(19) United States
(12) Patent Application Publication
(10) Pub. No.: US 2025/0077619 A1
(43) Pub. Date: Mar. 6, 2025

(54) Embedding Entity Matching

(71) Applicant: CrowdStrike, Inc., Sunnyvale, CA (US)

(72) Inventors: Brenden Thomas Bishop, San Marcos, CA (US); Amine Boubezari, Santa Clara, CA (US); Michael Avraham Brautbar, Wayland, MA (US)

(73) Assignee: CrowdStrike, Inc., Sunnyvale, CA (US)

(21) Appl. No.: 18/460,886

(22) Filed: Sep. 5, 2023

(51) Int. Cl. G06F 18/22; G06F 7/08

(52) U.S. Cl. CPC G06F 18/22; G06F 7/023; G06F 7/08; G06F 18/2113; G06F 2207/02

(57) ABSTRACT

Embedding entity matching greatly improves computer functioning. Different datasets are matched to a common entity using entity embeddings generated by a machine learning entity embedding model. The entity embeddings are converted to entity similarities, thus revealing the datasets associated with the common entity. Efficient matrix operations further improve computer functioning. Embedding entity matching thus quickly identifies common employee records and user accounts using less hardware resources, less electricity, and less time.

### BACKGROUND

The subject matter described herein generally relates to computers and to computer databases and, more particularly, the subject matter relates to fuzzy entity matching using n-gram embeddings.

Entity matching is a problem in many industries. As information and companies change over time, knowledge databases must be linked or merged to maintain correct records. A common situation involves company mergers and acquisitions. When two companies merge, their respective employee records, customer resource management (CRM) systems, enterprise resource planning (ERP) systems, and many other computer database records must also be merged and linked. Computer knowledge databases, though, may have thousands of database records across many sources, and these database records are dissimilar, untidy, and complex. Merging and entity matching of such diverse knowledge databases often becomes unruly and complicated.

### SUMMARY

Embedding entity matching greatly improves computer functioning. Different datasets are matched to a common entity using entity embeddings generated by a machine learning entity embedding model. The entity embeddings are converted to entity similarities, thus revealing the datasets that are associated with the common entity. Efficient matrix operations further improve computer functioning. Embedding entity matching thus quickly identifies, for example, common employee records and user accounts using less hardware resources, less electricity, and less time.

### BRIEF DESCRIPTION OF THE SEVERAL VIEWS OF THE DRAWINGS

The features, aspects, and advantages of entity matching powered by machine learning are understood when the following Detailed Description is read with reference to the accompanying drawings, wherein:

FIGS. 1-3 illustrate simple examples of entity matching;

FIGS. 4-5 illustrate more detailed examples of the entity matching;

FIGS. 6-7 illustrate examples of a cloud-computing environment;

FIG. 8 illustrates examples of database sourcing;

FIGS. 9-11 illustrate more examples of an entity identification service;

FIG. 12 is a block diagram illustrating the entity identification service;

FIG. 13 illustrates examples of a cyber security service;

FIG. 14 illustrates examples of service invocation;

FIGS. 15-18 illustrate more examples of improved computer functioning;

FIG. 19 illustrates examples of a method or operations for entity matching;

FIG. 20 illustrates more examples of a method or operations that determine a common entity;

FIG. 21 illustrates still more examples of a method or operations that determines the common entity associated with different user accounts; and

FIG. 22 illustrates a more detailed example of the operating environment.

### DETAILED DESCRIPTION

Some examples relate to entity matching using machine learning. Entity matching determines when two database records share, or are associated with, a common entity. While the common entity may be any shared identifier, computer accounts are a common example. As the years pass, our names may change, our mobile cell phone numbers may change, our addresses may change, and our employers change. All this user account information is stored in computer databases, and the user account information often becomes old and stale. Similarly, as businesses grow/buy/sell/merge/divest products and services, the number of employees and the user/customer accounts also become unruly and complicated. As yet another example, our subscription services (such as T-MOBILE®, NETFLIX®, PEACOCK®, DOLLAR SHAVE®, and HULU®) may frequently change with competitive pricing, changing content, and changing needs. All these employee records, user accounts, and other database records become complex, complicated, and even outdated.

Entity matching makes sense of these diverse database records. Entity matching reveals the common entity that links diverse database records to a single identifier. Years of diverse customer accounts, for example, may be linked and merged with a single customer, thus revealing a customer's changing purchasing/viewing habits over time. Years of employee records, as another example, may be linked to a single worker, thus consolidating old, stale employment information with fresh entries. Entity matching may thus be vital for accurate database records.

An entity identification service applies machine learning to entity matching. Examples of the entity identification service identify the common entity using a machine learning model. The machine learning model generates entity embeddings, and the entity embeddings are converted to entity similarities. The entity similarities reveal how similar different database records are to each other. The entity identification service may thus easily identify the common entity using the entity similarities.

Embedding-based entity matching will now be described more fully hereinafter with reference to the accompanying drawings. Embedding-based entity matching, however, may be embodied in many different forms and should not be construed as limited to the examples set forth herein. These examples are provided so that this disclosure will be thorough and complete and fully convey embedding-based entity matching to those of ordinary skill in the art. Moreover, all the examples of embedding-based entity matching are intended to encompass both structural and functional equivalents thereof. Additionally, it is intended that such equivalents include both currently known equivalents as well as equivalents developed in the future (i.e., any elements developed that perform the same function, regardless of structure).

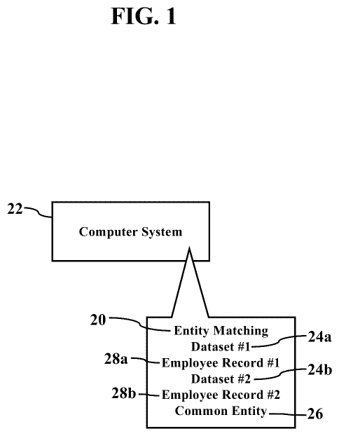

FIGS. 1-3 illustrate simple examples of entity matching 20. A computer system 22 determines when two computer datasets 24a and 24b share a common entity 26. While the datasets 24a and 24b may contain or reference any information, FIG. 1 illustrates a common example of slightly differing employee records 28. That is, the dataset 24a represents a first employee record 28a, and the dataset 24b represents a second employee record 28b. Let's say the dataset 24a represents employee “Mike Smith,” and the dataset 24b represents “Michael Smith.” The computer system 22 is programmed to determine if the different employee records 28a and 28b are actually the same employee. That is, the computer system 22 determines when the different employee records 28a and 28b share the common entity 26.

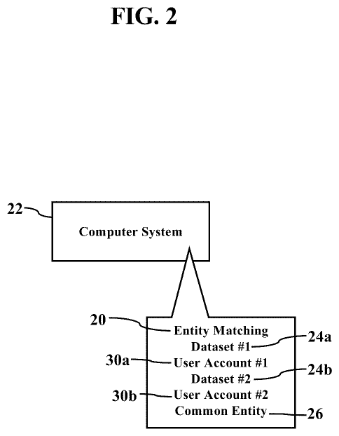

FIG. 2 illustrates another example of the entity matching 20. In this example, suppose that the datasets 24a and 24b are computer user accounts 30. That is, the first user account 30a may be associated with user “Debbie Collins” having email address debbie.collins@company.com. The second user account 30b may be associated with user “Deborah Collins” having email address dcollins@corp.com. The computer system 22 determines if the different user accounts 30a and 30b are actually associated with the same human person (e.g., the common entity 26).

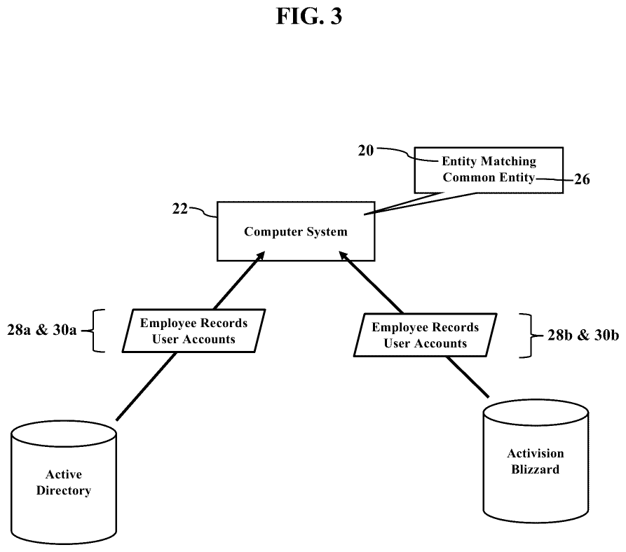

FIG. 3 illustrates still another example of the entity matching 20. In this example, suppose Microsoft's ACTIVE DIRECTORY® system must absorb or merge ACTIVISION BLIZZARD® records. Because Microsoft may soon complete an acquisition of Activision Blizzard, Inc., Microsoft's ACTIVE DIRECTORY® service may link the employee records 28 and the user accounts 30 associated with “Warcraft,” “Diablo,” “Overwatch,” “Call of Duty,” “Candy Crush,” and other gaming/e-sports services. The computer system 22 may thus be used to identify the common entities 26 between these millions of database records.

The entity matching 20 is vital in today's computerized world. As the years pass, our names may change, our mobile cell phone numbers may change, and our employers may change. Moreover, as businesses grow/buy/sell/merge/divest products and services, the number of employees and computer accounts becomes unruly and complicated. The computer system 22 providing the entity matching 20 is thus vital for accurate database records.

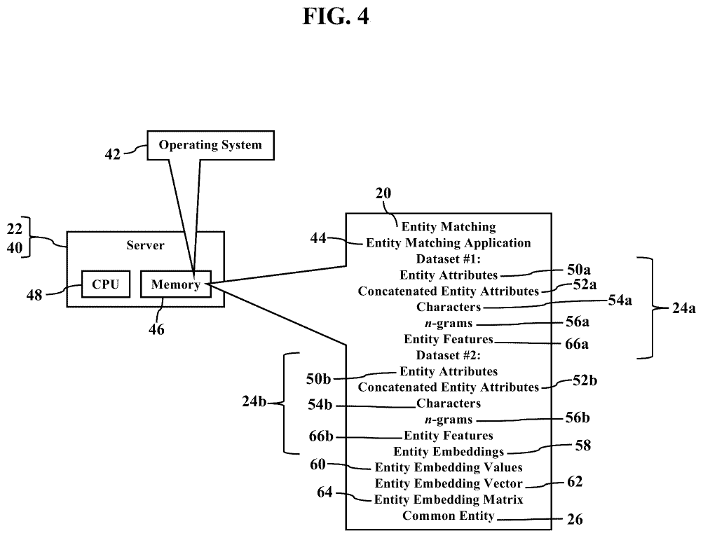

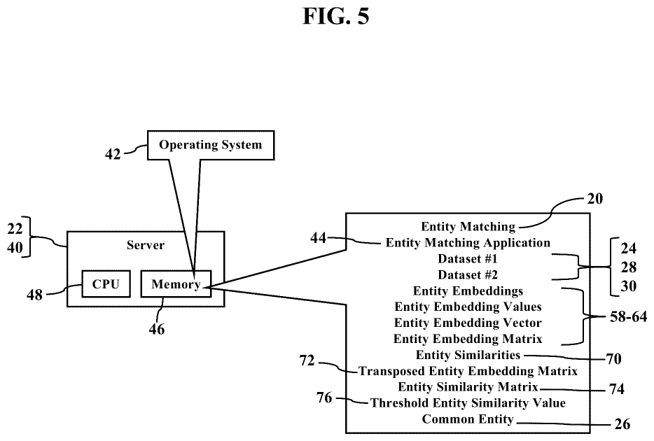

FIGS. 4-5 illustrate more detailed examples of the entity matching 20. FIG. 4 illustrates the computer system 22 as a server 40. The computer system 22, though, may be any processor-controlled device, as later paragraphs will explain. The server 40 stores and executes an operating system 42. The server 40 also stores an entity matching application 44 in a memory device 46. The server 40 has a hardware processor 48 that reads and executes the entity matching application 44. The entity matching application 44 may be a computer program, instruction(s), or code that instructs or causes the server 40 to provide the entity matching 20 as a service, perhaps on behalf of a service provider. The entity matching application 44 thus programs the server 40 to determine when the two computer datasets 24a and 24b share the common entity 26.

The server 40 processes and analyzes the datasets 24a and 24b. Each dataset 24a and 24b may include its corresponding entity attributes 50a and 50b. The entity attributes 50 may be any information that describes or is related to the dataset 24 (such as the employee records 28 and/or the user accounts 30, explained with reference to FIGS. 1-3). Some familiar examples of the entity attributes 50 include first name, last name, username, job title, department, physical address, email address, mobile phone number, birthdate, and any other identifying information or usage characteristics. Whatever the entity attributes 50 that are associated with each dataset 24, the entity matching application 44 may instruct the server 40 to read the dataset 24 and to concatenate some or all of its entity attributes 50, thus generating concatenated entity attributes 52. The entity matching application 44, for example, generates the concatenated entity attributes 52 as firstnamelastnameusernamejobtitledepartmentphysicaladdressemailaddressmobilephonenumber, resulting in a merged, concatenated text string. The entity matching application 44 may then instruct the server 40 to read n consecutive characters 54 (or n-grams 56) from the concatenated entity attributes 52. The entity matching application 44, for example, may extract two (2) consecutive characters 54 as bi-grams, three (3) consecutive characters 54 as tri-grams, or any another desired sequential combination. Whatever the size of the n-grams 56, the entity matching application 44 may then generate entity embeddings 58 as outputs. While the entity embeddings 58 may have many different representations, each entity embedding 58 is commonly represented as entity embedding values 60 associated with an entity embedding vector 62 and/or an entity embedding matrix 64. The entity matching application 44 receives multiple n-grams 56 which are sampled from the memory device 46. The entity matching application 44 generates the entity embeddings 58 from the n-grams 56 as inputs, with n being any integer value. The n-grams 56 may be further represented as entity features 66. The entity matching application 44 generates the entity embeddings 58 (such as the values 60 of the vector 62 and/or the matrix 64) as outputs.

As FIG. 5 illustrates, entity similarities 70 may then be determined. Once the entity matching application 44 generates the entity embeddings 58 (such as the entity embedding matrix 64) as outputs, the entity matching application 44 may, if configured, generate ranked entity embeddings by ranking the values associated with the entity embeddings 58. The entity matching application 44 may additionally or alternatively generate a transposed entity embedding matrix 72 by transposing the entity embedding matrix 64 (e.g., diagonal flipping by switching row and column indices). The entity matching application 44 may generate an entity similarity matrix 74 by multiplying the entity embedding matrix 64 by its transposed entity embedding matrix 72. The entity similarity matrix 74 reveals the entity similarities 70 between the datasets 24a and 24b. Any entity similarities 70 above a threshold entity similarity value 76, for example, may indicate the employee records 28 and/or the user accounts 30 sharing the common entity 26.

The entity matching 20 greatly improves computer functioning. The common entities 26 between the datasets 24a and 24b yield faster information retrieval. Because the entity matching application 44 identifies the common entity 26 between the different datasets 24a and 24b, less hardware resources (e.g., processor cycles, memory usage, and read/write operations) are required to retrieve common database entries. Because the hardware processor 48 requires reduced hardware resources, the computer system 22 consumes less electrical power and generates less waste heat. The entity matching application 44 greatly improves computer functioning.

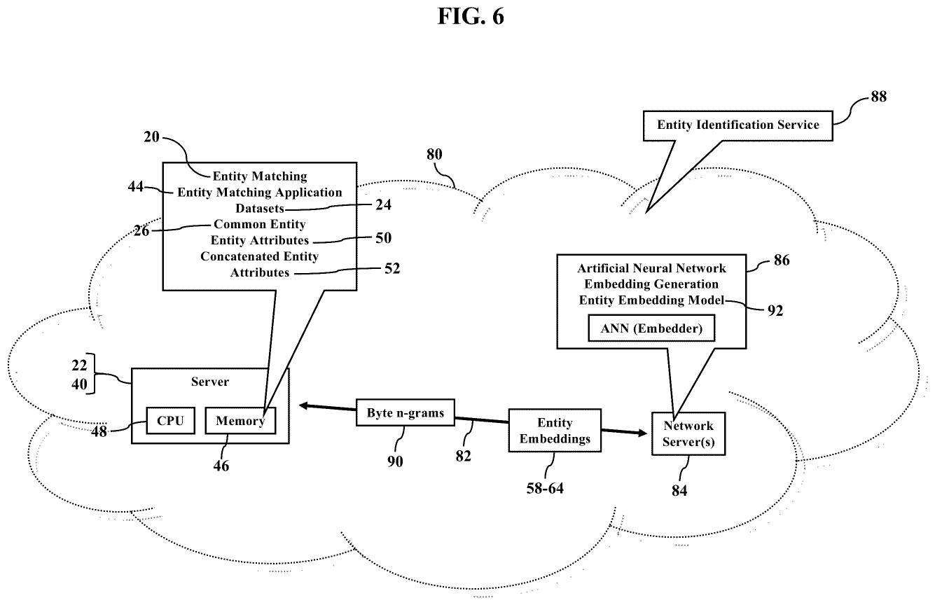

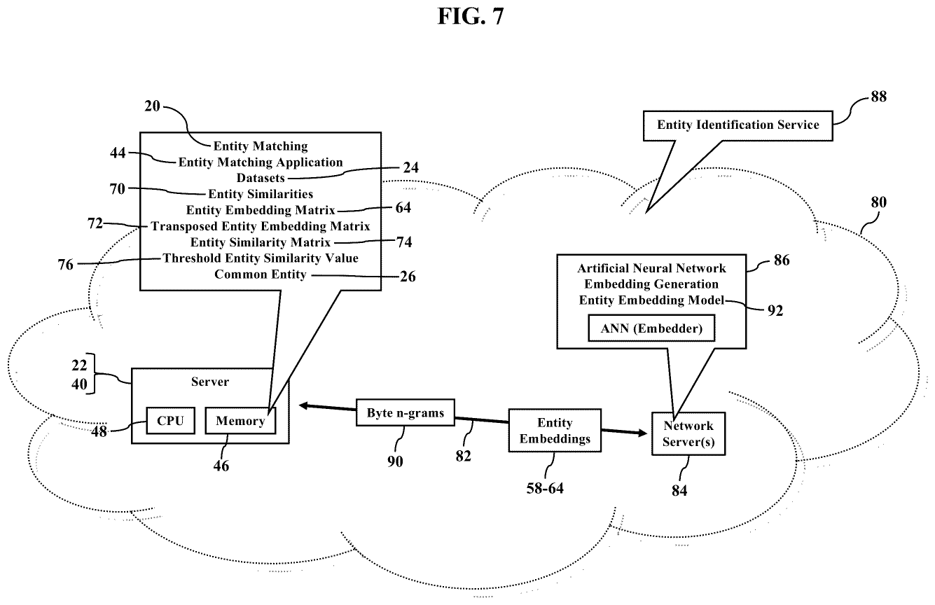

FIGS. 6-7 illustrate examples of a cloud-computing environment 80. In this example, the computer system 22 (again illustrated as the server 40) communicates via a network interface to a communications network 82 (e.g., public Internet, private network, and/or hybrid network). The server 40 may thus communicate with other servers, devices, computers, or other network members 84 operating within, or affiliated with, the cloud-computing environment 80. The server 40, for example, may be a component of an artificial neural network 86. The artificial neural network 86 may be one or many of the network members 84 operating within, or affiliated with, the cloud-computing environment 80. The server 40, in particular, interfaces with the cloud-computing environment 80 and/or the artificial neural network 86 to provide an entity identification service 88. The entity identification service 88 is one of perhaps many cloud services provided by the cloud-computing environment 80. The artificial neural network 86 is taught, perhaps using deep learning, to determine when two inputs (such as the datasets 24) share the common entity 26.

The cloud-computing environment 80 may analyze bits/bytes of data. The entity matching application 44, for example, may instruct the server 40 to read the dataset 24 and to concatenate some or all of the corresponding entity attributes 50, thus generating the corresponding concatenated entity attributes 52. Here, though, the concatenated entity attributes 52 may be bit/byte strings representing the concatenated entity attributes 52. The entity matching application 44 may thus instruct the server 40 to read n consecutive bits and/or bytes (such as byte n-grams 90) from the bit/byte strings representing the concatenated entity attributes 52. The entity matching application 44 may instruct the server 40 to store the byte n-grams 90 in the memory device 46, perhaps as a byte buffer. The server 40 may then send/feed/load the contents of the byte buffer to the artificial neural network 86. The artificial neural network 86 receives multiple n consecutive bytes (or the byte n-grams 90) which are sampled from the buffering memory device 46. The artificial neural network 86 executes a machine learning entity embedding model 92 that generates the entity embeddings 58 from the byte n-grams 90 as inputs, with n being any integer value. These n consecutive bytes may even be represented as nibbles (e.g., the embedder's entity features), thus making the input size equal to two times n (2*n). These nibble-formatted bytes are passed as inputs to the artificial neural network 86. The artificial neural network 86 may thus function or perform as an entity embedder and generate the entity embeddings 58 as outputs. Again, while the entity embeddings 58 may have many different representations, each entity embedding 58 is commonly represented as the entity embedding values 60 associated with the entity embedding vector 62 and/or the entity embedding matrix 64. The artificial neural network 86 receives multiple byte n-grams 90 which are sampled from the memory device 46. The artificial neural network 86 generates the entity embeddings 58 from the byte n-grams 90 as inputs, with n being any integer value. The artificial neural network 86 generates the entity embeddings 58 (such as the values 60 of the vector 62 and/or the matrix 64) as outputs.

As FIG. 7 illustrates, the entity similarities 70 may then be determined. Once the artificial neural network 86 generates the entity embeddings 58 (such as the entity embedding matrix 64) as outputs, the artificial neural network 86 may send the entity embeddings 58 to the server 40. When the server 40 receives the entity embeddings 58, the server 40 may continue providing the entity identification service 88. The entity matching application 44, for example, receives the entity embedding matrix 64, generates the transposed entity embedding matrix 72, and generates the entity similarity matrix 74 (by multiplying the entity embedding matrix 64 by its transposed entity embedding matrix 72, as previously explained). The entity matching application 44 may then instruct the server 40 to inspect and to compare the entity similarities 70 revealed by the entity similarity matrix 74. The entity matching application 44 may generate ranked entity similarities by ranking the entity similarities 70 in low/high value order. The entity matching application 44 may compare the entity similarities 70 to the threshold entity similarity value 76. If any database entries have values for the entity similarity 70 that equal, exceed, or otherwise satisfy the threshold entity similarity value 76, then the entity matching application 44 may execute logical rules or statements that determine the corresponding datasets 24 (such as the employee records 28 and/or user accounts 30 illustrated in FIGS. 1-2) qualify as having the common entity 26.

The entity identification service 88 greatly improves any knowledge database. The entity identification service 88 determines the common entity 26, regardless of database content. That is, the entity matching application 44 may accept any dataset 24 having any electronic content. Whatever the bytes/bits of the dataset 24, the entity matching application 44 may concatenate any bit/byte combination (such as the byte n-grams 90), generate the entity embeddings 58, and determine the entity similarities 70. As a simple example, the entity identification service 88 is especially helpful with Microsoft's ACTIVE DIRECTORY® system. This directory service dates to about 1999 and has since been adopted by many companies. Because Microsoft's ACTIVE DIRECTORY® system has been commonly used for many years, and because companies grow/merge/change over these many years, Microsoft's ACTIVE DIRECTORY® system has many user accounts that may be redundant, unruly, and complicated. The entity identification service 88 inputs any datasets 24 (such as numerous ACTIVE DIRECTORY® user accounts 30) and reveals what human person is tied to the different user accounts 30. Because Microsoft's ACTIVE DIRECTORY® system may be ubiquitous, its knowledge database may be too complicated and untidy to easily determine a common email address or some other kind of a strong linked identifier (e.g., the entity attribute 50). The entity identification service 88 may ingest hundreds or even thousands of different datasets 24 (such as years of legacy employee records 28 and/or user accounts 30) with varying entity attributes 50 (e.g., first name, last name, supervisor, department, job title, email domain, etc.). The entity identification service 88 ingests all these diverse datasets 24 and finds the employee records 28 and/or the user accounts 30 that belong to the same person (e.g., the common entity 26).

The entity embeddings 58 need only be briefly explained. The entity identification service 88 extracts the byte n-grams 90 and generates the entity embeddings 58. While any component of the cloud-computing environment may extract the byte n-grams 90, for simplicity, this example illustrates the entity matching application 44 functioning or operating as a feature extractor that extracts the byte n-grams 90. In this example, the artificial neural network 86 then provides an embedding service that generates the entity embeddings 58. Even though the artificial neural network 86 may have any number of embedding layers, the exemplary implementation may have six (6) embedding layers, including an input layer and an output layer of size sixty four (64). The artificial neural network 86 may thus output the entity embedding vector 62 and/or the entity embedding matrix 64 having sixty-four (64) values. Each entity embedding 58 represents the 64-valued encoding of the corresponding byte n-gram 90. Additional details for the entity embeddings 58 are found in U.S. Patent Application Publication 2019/0007434 to McLane, et al. (which has since issued as U.S. Pat. No. 10,616,252) and in U.S. Patent Application Publication 2020/0005082 to Cazan, et al. (which has since issued as U.S. Pat. No. 11,727,112), with each document incorporated herein by reference in its entirety.

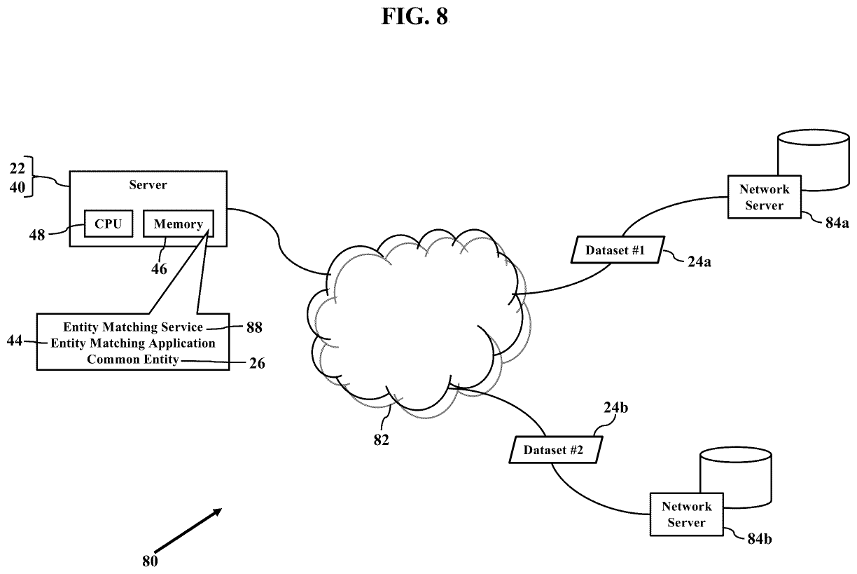

FIG. 8 illustrates examples of database sourcing. While the datasets 24a and 24b may be obtained from any source, FIG. 8 illustrates network database retrieval. Because the server 40 has the network interface to any communications network 82 (e.g., public Internet, private network, and/or hybrid network), the server 40 may retrieve the datasets 24a and 24b from remote sources. The entity matching application 44, for example, may instruct the server 40 to issue queries and to retrieve any input data, such as the datasets 24a and 24b. The server 40 may thus query any network resource to obtain the datasets 24a and 24b. FIG. 8 thus illustrates network member 84a (such as a remote network server) storing the dataset 24a and network member 24b (such as another remote server) storing the dataset 24b. When the server 40 is tasked with providing at least a portion of the entity identification service 88, the entity matching application 44 may instruct the server 40 to retrieve the datasets 24a and 24b from remote sources.

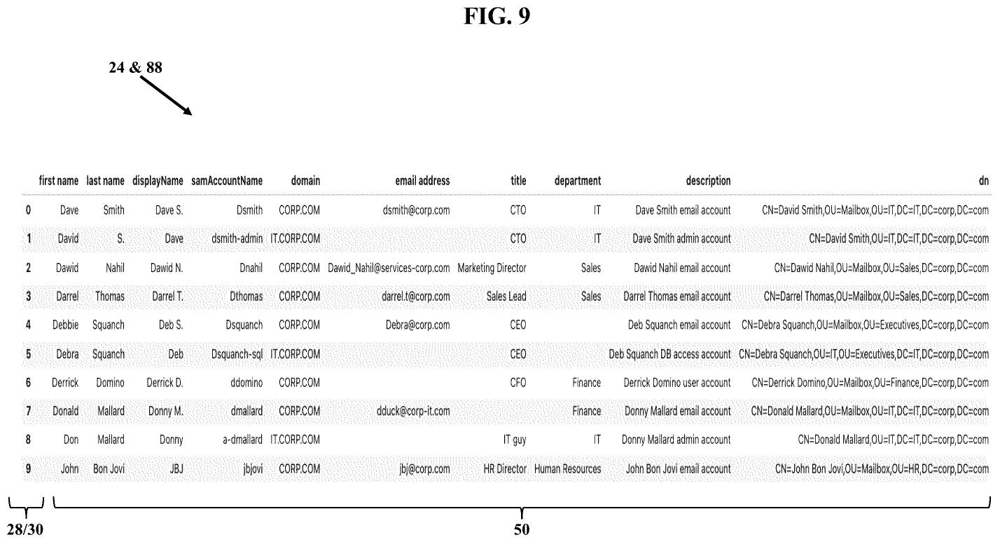

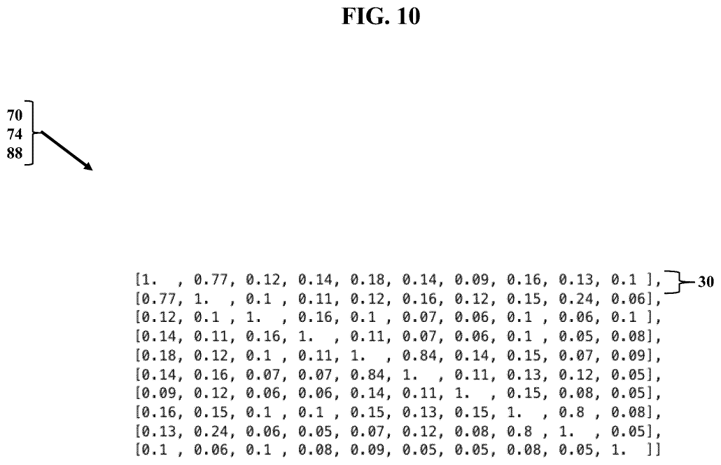

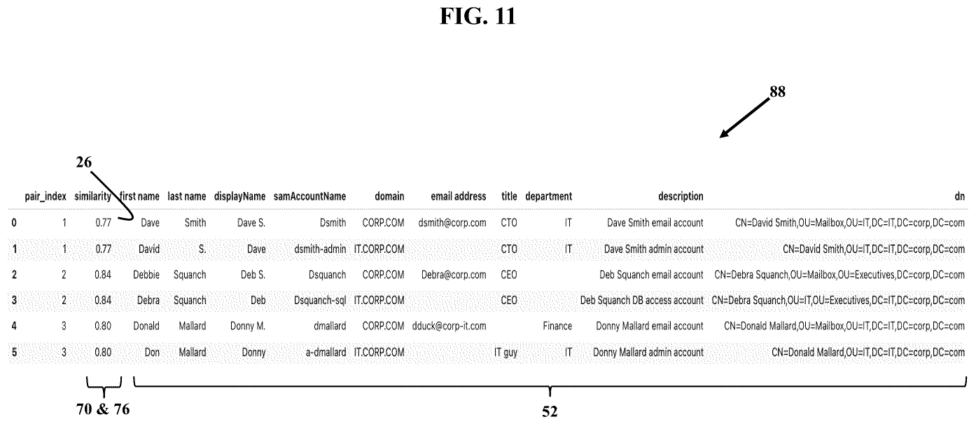

FIGS. 9-11 illustrate more examples of the entity identification service 88. FIG. 9 illustrates an example of the dataset 24 that may be retrieved by the computer system 22 (such as the server 40 illustrated in FIGS. 1-8). The dataset 24 may include any range or amount of database entries. FIG. 9, for example, illustrates several employee records 28 and/or user accounts 30 and their corresponding entity attributes 50. While the dataset 24 may have any structure and formatting, FIG. 9 illustrates tabular database records having row and columnar entries. The entity identification service 88 concatenates the entity attributes 50, creates the byte n-grams 90, and generates the entity embeddings 58 (as this disclosure above explained). FIG. 10 thus illustrates examples of the entity similarity matrix 74. The entity similarity matrix 74 is symmetric. The largest non-one values in each row/column index which other user account 30 has the most in common with a target zero. The entity identification service 88 may inspect and to compare the entity similarities 70 to the threshold entity similarity value 76 (as explained with reference to FIGS. 5-7). As FIG. 11 illustrates, the entity identification service 88 may thus filter out and identify high-value pairs, perhaps those entity similarities 70 equal to or exceeding the threshold entity similarity value 76. The high-valued pairs, in other words, may be ruled as the different user accounts 30 having the common entity 26. As simple examples, in FIG. 11 the entity identification service 88 has removed or filtered out any similarities 70 having values less than about (0.75). FIG. 11 thus illustrates that pairwise indices 0 and 1 have the similarity 70 of 0.77, thus potentially indicating that employee records 28 and/or user accounts 30 satisfy the minimum threshold entity similarity value 76 for establishing the common entity 26. Similarly, indices 2 and 3 (similarity of 0.84) share the common entity 26 and indices 4 and 5 (similarity of 0.80) share the common entity 26.

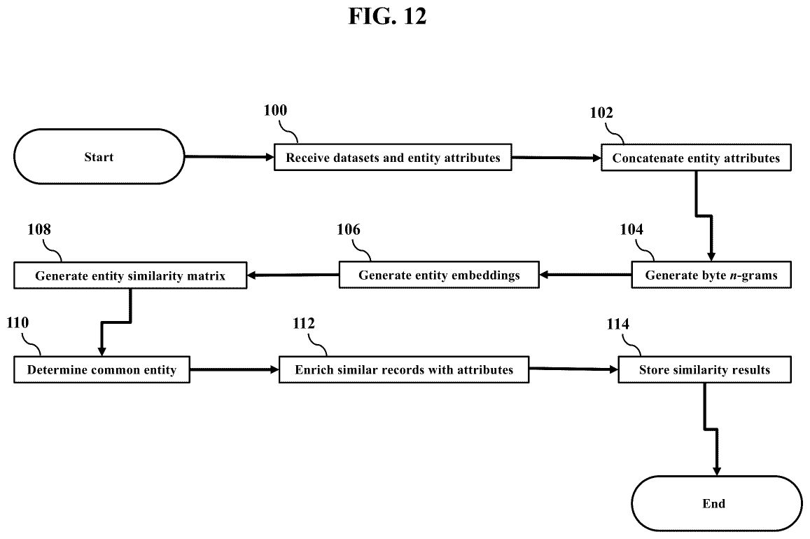

FIG. 12 is a block diagram illustrating more examples of the entity identification service 88. The entity identification service 88 receives the datasets 24 and their corresponding entity attributes 50 (Block 100). As a simple example, the entity matching application 44 may generate a graphical user interface for display by the computer system 22 (such as by a monitor, capacitive screen, or any other display device). A user of the computer system 22 may thus make tactile inputs that select the datasets 24 and their corresponding entity attributes 50. The entity matching application 44, however, may have code that specifies network addresses, drives, folders, filenames, and/or other sources providing/storing the inputs. However the datasets 24 are defined or selected, the entity identification service 88 concatenates the entity attributes 50 into a single bit string for each entity (such as each user account 30) (Block 102). Each concatenated entity attribute 50 is broken into fixed-width substrings (such as the byte n-grams 90) (Block 104). The entity embeddings 58 are generated (Block 106), thus revealing and assigning a numerical importance value, and thus embedding the full concatenated entity attribute 50 into the numeric entity embedding vector 62. The entity similarity matrix 74 is generated (Block 108). The entity similarity matrix 74 reveals the common entity 26 according to pairs of the entity similarities 70 (Block 110). The similar datasets 24 (such as the user accounts 30) and/or the common entity 26 may be enriched by augmenting the entity attributes 50 and other descriptive information (Block 112). The entity identification service 88 may log and store the results (such as the entity embedding matrix 64, the entity similarity matrix 74, and the entity attributes 50) (Block 114). The entity identification service 88 may thus map entity information into a clever numeric representation from which a single number measure of the entity similarity 70 may be computed via efficient matrix multiplication.

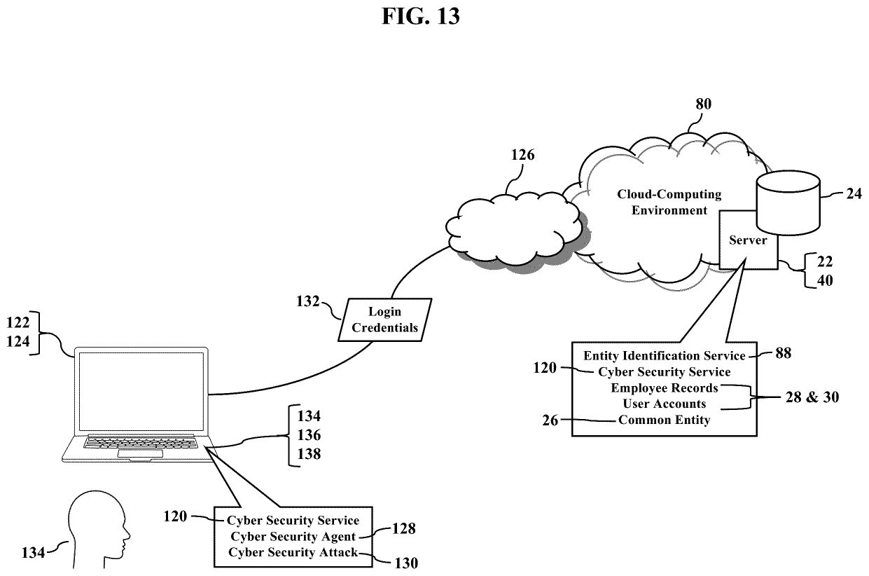

FIG. 13 illustrates examples of a cyber security service 120. Here the cloud-computing environment 80 may provide both the entity identification service 88 and the cyber security service 120 to clients/customers. Indeed, the entity identification service 88 may be an important component of detecting malware and other cyber security attacks. Cyber security attackers often first compromise a single user account 30, thus gaining/granting access to a single remote client machine 122 from phishing or a misplaced credential in a public space. Because users frequently have more than one user account 30 (such as a base user account and a more highly privileged account), attackers can often gather more account credentials by accessing the client machine 122 where users log in with both accounts. The attacker will typically use a single stolen account to access network resources (searching for targets and ways to get to the targets), which might be noticed by cyber security defenders (e.g., an indicator of concern/compromise, an anomaly). However, defenders will probably only see the “bad” access by a single account, not knowing which other accounts may also be compromised/controlled by the attacker. Knowing which accounts belong to the same person (e.g., the common entity 26) may be critical for responding to attacks because defenders need to respond to compromised identities (everything related to a person), not just compromised accounts.

FIG. 13 thus illustrates examples of integrated cloud-based services. The client machine 122 interfaces with the cloud-computing environment 80. FIG. 13 illustrates the client machine 122 as a remote laptop computer 124, but the client machine 122 may be any smartphone, tablet, server, or other computer. The laptop computer 124 has a network interface to an access network 126, thus allowing the laptop computer 124 to establish network communications with the cloud-computing environment 80 and/or with the computer system 22 (again illustrated as the server 40). The laptop computer 124 may store and execute an endpoint cyber security agent 128. The cyber security agent 128 cooperates with the cloud-computing environment 80 to provide the entity identification service 88 and/or the cyber security service 120. The cyber security agent 128, for example, monitors the laptop computer 124 and reports any suspicious activity that may indicate evidence of a cyber security attack 130. The cyber security agent 128, for example, may intercept any login credentials 132 entered by a user 134 of the laptop computer 124. The cyber security agent 128 may forward, upload, or transfer the login credentials 132 to the cloud-computing environment 80 for the entity identification service 88 and/or for the cyber security service 120. The cyber security agent 128 may also forward, upload, or transfer any other information, such as machine identifier (e.g., MAC address, model, serial number), GPS/router location, and/or IP address. When the cloud-computing environment 80 receives the login credentials 132 and any other information, the cloud-computing environment 80 may route or forward the login credentials 132 and any other information to the network address (e.g., IP address) associated with the server 40. When the server 40 receives the login credentials 132 and any other information, the server 40 may then provide at least a portion of the entity identification service 88 and/or the cyber security service 120 by determining the common entity 26 with other records/accounts 28/30 (such as this disclosure above explains).

The cyber security agent 128 may have kernel-level permissions. The cyber security agent 128 is installed on the laptop computer 124, is stored by a memory device 134, and is executed by a hardware processor 136. The cyber security agent 128, for example, may have kernel-level components having kernel-level permissions to a kernel of an operating system 138. The cyber security agent 128 may additionally have user-mode components having user-level permissions to a user mode of the operating system 138. The cyber security agent 128 may include code or instructions that scan and monitor the laptop computer 124 for events, communications, processes, activities, behaviors, data values, usernames/logins, locations, contexts, and/or patterns that indicate evidence of the cyber security attack 130. Because the laptop computer 124 has kernel-level permissions, the cyber security agent 128 may monitor any kernel-level activity and/or any user-mode activity conducted by the laptop computer 124. The cyber security agent 128 may register for and receive kernel-level notifications and call backs from the kernel of the operating system 138. The cyber security agent 128 may thus transfer the login credentials 132 to the cloud-computing environment 80 for the entity identification service 88 and/or for the cyber security service 120.

The entity identification service 88 and the cyber security service 120 greatly improve computer functioning. Because the entity identification service 88 and the cyber security service 120 may monitor logins and accounts at the laptop computer 124, the identity identification service 88 and the cyber security service 120 protects the laptop computer 124 from phishing attacks striking multiple user accounts 30. By knowing which user accounts 30 belong to the same person (e.g., the common entity 26), the entity identification service 88 and the cyber security service 120 may quickly detect and defend compromised identities (everything related to a person), not just compromised accounts.

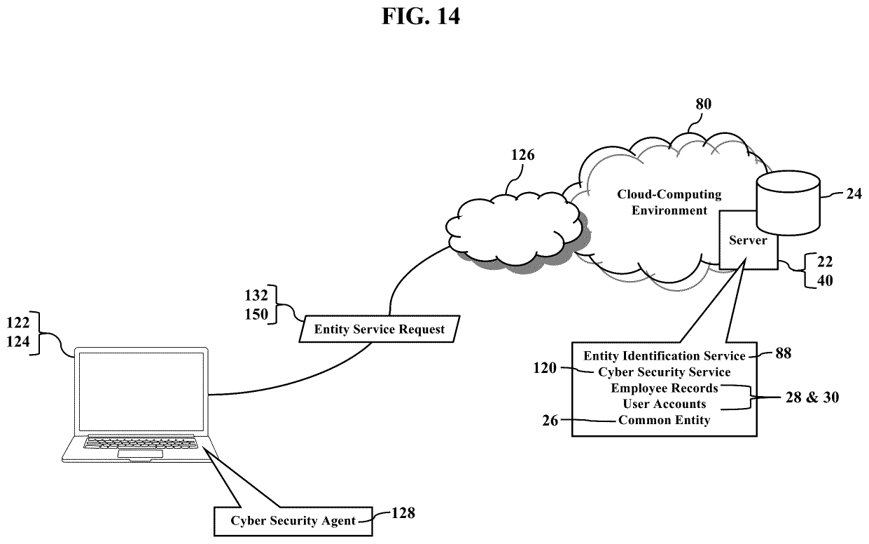

FIG. 14 illustrates examples of service invocation. In these examples, the cyber security agent 128 sends an entity service request 150 to the cloud-computing environment 80. The entity service request 150 may include or specify the login credentials 132. When the cloud-computing environment 80 receives the entity service request 150, the cloud-computing environment 80 may route or forward the entity service request 150 and/or the login credentials 132 to the network address (e.g., IP address) associated with the server 40. When the server 40 receives the entity service request 150 and/or the login credentials 132, the server 40 may then provide at least a portion of the entity identification service 88 by determining the common entity 26 associated with the login credentials 132 (such as this disclosure above explained).

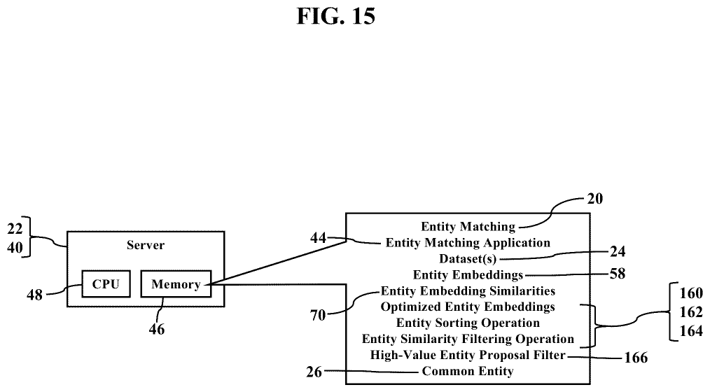

FIGS. 15-18 illustrate more examples of improved computer functioning. As one may now realize, the entity identification service 88 may utilize matrix operations. These matrix operations, though, could be very complex and resource intensive. Each entity embedding 58, as an example, may have many components (such as the sixty-four (64) values, as above explained). The entity identification service 88 may require many randomly sampled byte n-grams 90, and each byte n-gram 90 may be associated with its corresponding 64-valued entity embedding vector 62 and 64-valued entity embedding matrix 64. In plain words, the matrix operations may require much processor, memory, and network resources, and these hardware/software resources consume much electrical power and generate much electrical waste heat. The complex and resource intensive matrix operations may thus require much time and much hardware/network resources to identify the common entity 26.

FIGS. 15-18, though, illustrate still more improved computer functioning. The inventors have discovered that the entity identification service 88 may be greatly simplified without sacrificing accuracy. After the entity identification service 88 computes the entity embedding(s) 58, the entity matching application 44 may receive and store the entity embeddings 58. For simplicity, FIG. 15 illustrates the entity embeddings 58 locally stored within the local memory device 46. The entity embeddings 58, though, may be remotely stored to, and accessed from, any networked location available to the server 40. The entity matching application 44 may then reduce and simplify the entity embedding(s) 58. The entity matching application 44 may instruct the server 40 to generate optimized entity embeddings 160 by sorting the entity embeddings 58 (perhaps via an entity sorting operation 162) and by removing or filtering out low-valued entity similarities 70 (perhaps via an entity similarity filtering operation 164). The entity matching application 44 may thus implement a high-value entity proposal filter 166 that optimizes the entity embedding(s) 58. The high-value entity proposal filter 166 reduces the time and hardware complexity of determining the entity embedding similarities 70 from an order of quadratic in the number of elements, n, to the order of (n*log n). Indeed, in practicality, the high-value entity proposal filter 166 reduces/simplifies the entity embedding similarities 70 to just linear in n. because the entity sorting operation 162 takes negligible time in practice. The embedding similarity optimization takes advantage of two attributes of the entity matching problem: first, some data fields (associated with the entity attributes 52) have a high correlation to high similarity matches, such that if the entity matching application 44 sorts on those fields/attributes 52, the entity matching application 44 may have a very good chance of finding the top entity matches for an embedding 58 close to it in the entity embedding matrix 64 after sorting; second, the entity matching application 44 may only analyze very high quality embedding similarity matches. This means that the entity matching application 44 may sort on those high correlation fields/attributes 52, and only search a local space around each embedding 58 to get all the high quality matches for that embedding 58. In other words, the embedding similarity optimization may only care about high quality matches, which means the embedding similarity optimization works well since all the high quality matches tend to group near the target embedding after the sort. Empirically, this approach has a recall of 99-100% on matches with a quality similarity 70 of greater than 0.9.

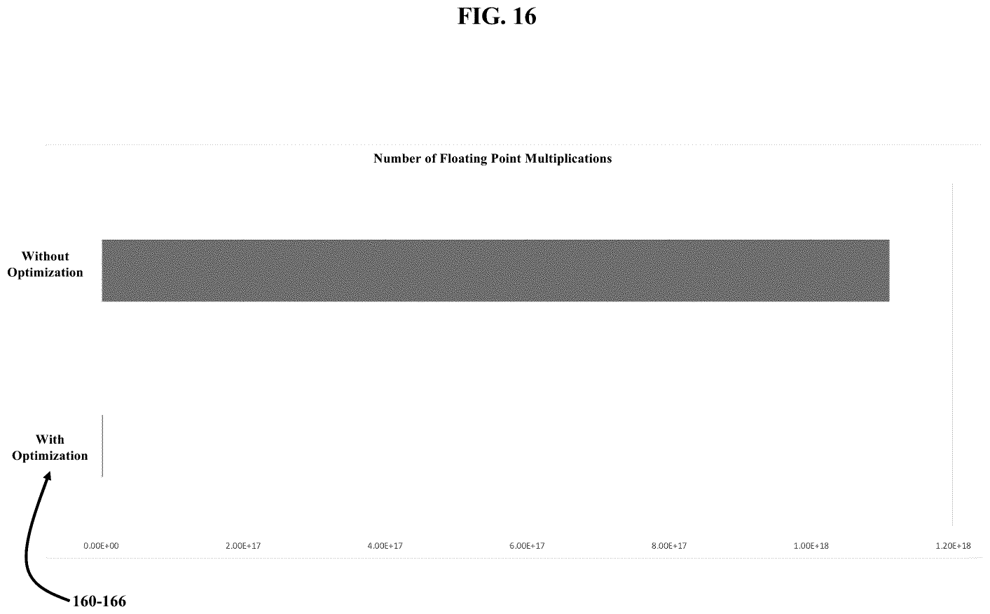

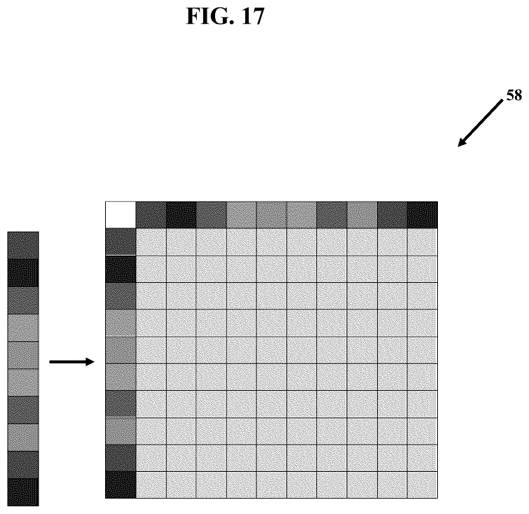

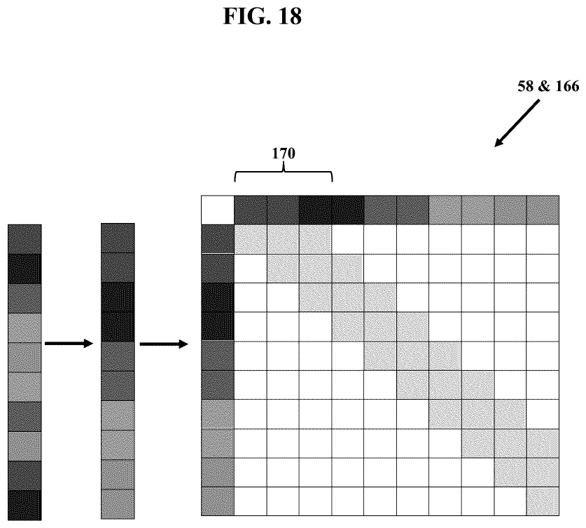

FIGS. 16-18 dramatically visualize the improved computer functioning. In this example, a large corporation may have many legacy and current datasets 24 (such as the employee records 28 and the user accounts 30), thus resulting in the entity embedding matrix 64 having a shape of (4,896,288 by 46,652). The standard matrix multiplication would involve (1.11×10e¹⁸) floating point multiplications. That is, the computer system 22 would have to perform (1.11×10e¹⁸) floating point multiplications. However, by implementing the high-value entity proposal filter 166, the entity matching application 44 implements an optimized approach that only needs (2.28×10e¹⁵) floating point computations. The high-value entity proposal filter 166 thus results in a 486-times decrease in the number of floating point multiplications and compute time expended by the computer system 22, which is illustrated by FIG. 16. Moreover, FIGS. 17-18 further illustrate the improved computer functioning. FIG. 17 illustrates a block plot of the entity embeddings 58 and an exact matrix multiplication. Each matching grey-scaled or patterned block represents an embedding 58. Embeddings 58 illustrated with the same grey-scaling or pattern indicate user accounts 30 belonging to the same user (e.g., the common entity 26). Here, each embedding 58 is compared against every other embedding 58. Each block (e.g., each embedding 58), in particular, indicates one embedding multiplication. FIG. 18, though, illustrates the optimized approach that implements the high-value entity proposal filter 166. Here, by first sorting, and then by only multiplying entity embeddings 58 in a local search space 170 of the embeddings 58. While the local search space 170 may include any number of the embeddings 58, FIG. 18 illustrates an adjacency of +/−one (1) embedding 58. That is, the local search space 170 is only three (3) entity embeddings 58 (verses searching all 64 embeddings). Note how the number of blocks (e.g., embedding computations) decreases while the recall of matches is the same. The embedding similarity optimization thus still finds the top entity matches while utilizing nearly 500 times less hardware resources.

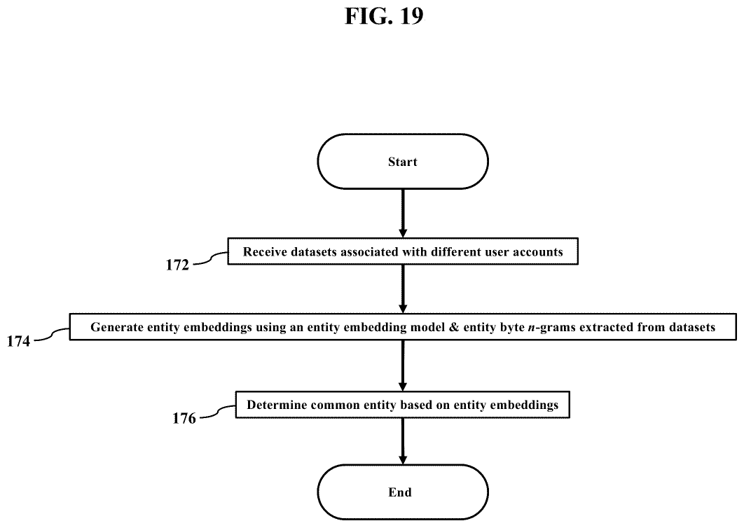

FIG. 19 illustrates examples of a method or operations for entity matching. The computer system 22 receives the datasets 24 associated with the different user accounts 30 (Block 172). The computer system 22 generates the entity embeddings 58 using the entity embedding model 92 and the entity byte n-grams 90 extracted from the datasets 24 (Block 174). The computer system 22 determines the common entity 26 associated with the different user accounts 30 based on the entity embeddings 58 (Block 176).

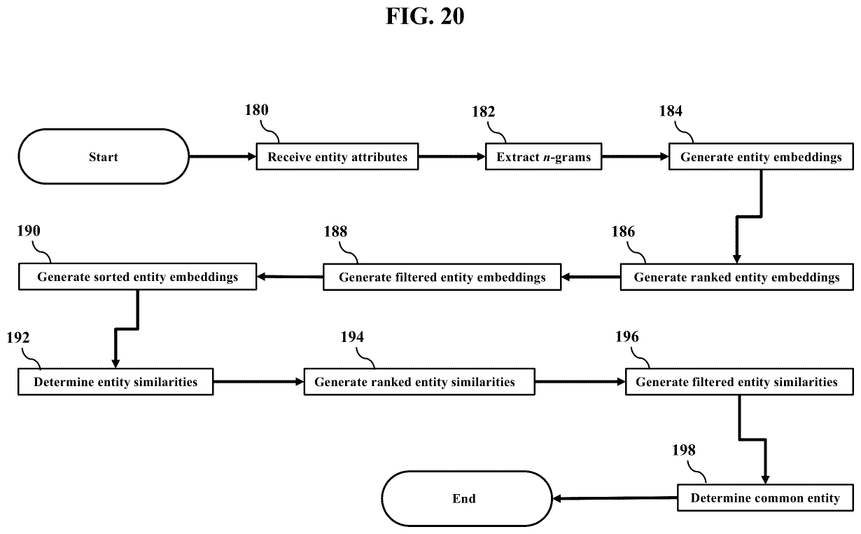

FIG. 20 illustrates more examples of a method or operations that determine the common entity 26. The computer system 22 receives the entity attributes 50 associated with different entities (Block 180) and extracts the entity n-grams 56 (such as the byte n-grams 90) (Block 182). The computer system 22 generates the entity embeddings 58 using the entity n-grams 56 (such as the byte n-grams 90) (Block 184). The computer system 22 may generate ranked entity embeddings by ranking values associated with the entity embeddings 58 (Block 186). The computer system 22 may generate filtered entity embeddings by filtering the entity embeddings 58 according to a threshold entity embedding value (Block 188). Some entity embeddings 58, for example, may have values or importances that are too small and may be disregarded, ignored, or removed. The computer system 22 may additionally or alternatively generate reduced entity embeddings by generating sorted entity embeddings by sorting the entity embeddings 58 according to an embedding adjacency that corresponds to highly-correlating entity attributes 52 (Block 190). The computer system 22 determines the entity similarities 70 associated with the entity embeddings 58 (Block 192). The computer system 22 may generate ranked entity similarities by ranking the entity similarities 70 (Block 194). The computer system 22 may generate filtered entity similarities by filtering the entity similarities 70 according to the threshold entity similarity value 76 (Block 196). The computer system 22 determines the common entity 26 (Block 198).

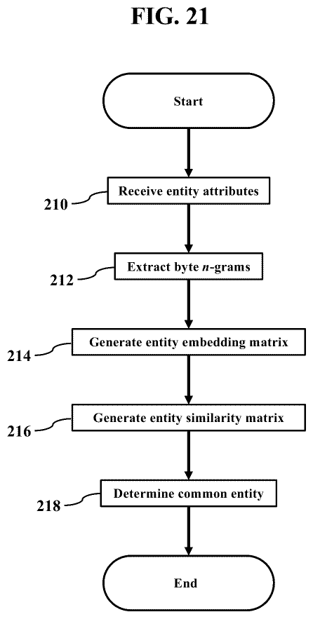

FIG. 21 illustrates still more examples of a method or operations that determines the common entity 26 associated with the different user accounts 30. The entity attributes 52 associated with the different user accounts 30 are received (Block 210). The entity byte n-grams 90 are extracted (Block 212) and the entity embedding matrix 64 is generated using the entity embedding model 92 and the entity byte n-grams 90 (Block 214). The entity similarity matrix 74 is generated using the entity embedding matrix 64 (Block 216). The common entity is determined (Block 218).

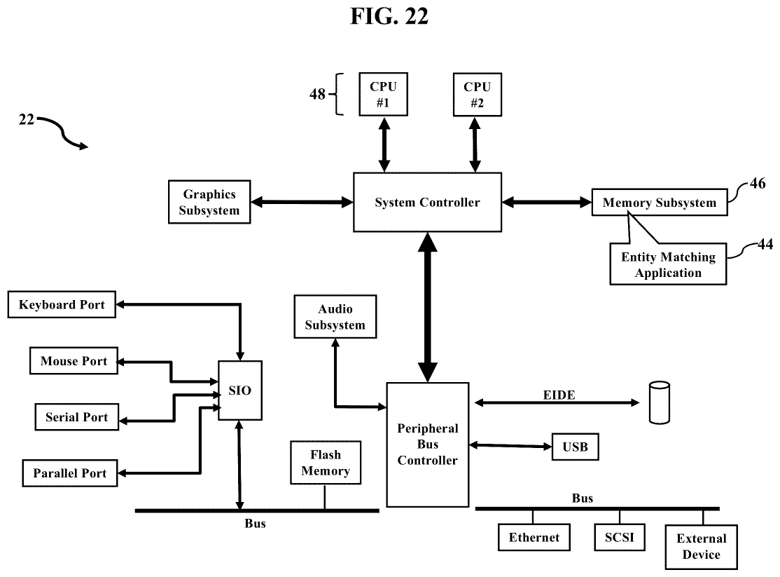

FIG. 22 illustrates a more detailed example of the operating environment. FIG. 22 is a more detailed block diagram illustrating the computer system 22. The entity matching application 44 is stored in the memory subsystem or device 46. One or more of the hardware processors 48 communicate with the memory subsystem or device 46 and execute the entity matching application 44. Examples of the memory subsystem or device 46 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. Because the computer system 22 is known to those of ordinary skill in the art, no detailed explanation is needed.

The computer system 22 may have any embodiment. This disclosure mostly discusses the computer system 22 as the server 40. The entity identification service 88, however, may be easily adapted to mobile computing, wherein the computer system 22 may be a smartphone, a laptop computer, a tablet computer, or a smartwatch. The entity identification service 88 may also be easily adapted to other embodiments of smart devices, such as a television, an audio device, a remote control, and a recorder. The entity identification service 88 may also be easily adapted to still more smart appliances, such as washers, dryers, and refrigerators. Indeed, as cars, trucks, and other vehicles grow in electronic usage and in processing power, the entity identification service 88 may be easily incorporated into any vehicular controller.

The above examples of the entity identification service 88 may be applied regardless of the communications network 82 and networking environment. The entity identification service 88 may be easily adapted to stationary or mobile devices having wide-area networking (e.g., 4G/LTE/5G/6G cellular), wireless local area networking (WI-FI®), near field, and/or BLUETOOTH® capability. The entity identification service 88 may be applied to stationary or mobile devices utilizing any portion of the electromagnetic spectrum and any signaling standard (such as the IEEE 802 family of standards, GSM/CDMA/TDMA or any cellular standard, and/or the ISM band). The entity identification service 88, however, may be applied to any processor-controlled device operating in the radio-frequency domain and/or the Internet Protocol (IP) domain. The entity identification service 88 may be applied to any processor-controlled device utilizing a distributed computing network, such as the Internet (sometimes alternatively known as the “World Wide Web”), an intranet, a local-area network (LAN), and/or a wide-area network (WAN). The entity identification service 88 may be applied to any processor-controlled device utilizing power line technologies, in which signals are communicated via electrical wiring. Indeed, the many examples may be applied regardless of physical componentry, physical configuration, or communications standard(s).

The environment may utilize any processing component, configuration, or system. For example, the entity identification service 88 may be easily adapted to execute by any desktop, mobile, or server central processing unit 48 or chipset offered by INTEL®, ADVANCED MICRO DEVICES®, ARM®, APPLE®, TAIWAN SEMICONDUCTOR MANUFACTURING®, QUALCOMM®, or any other manufacturer. The computer system 22 may even use multiple central processing units 48 or chipsets, which could include distributed processors or parallel processors in a single machine or multiple machines. The central processing unit 48 or chipset can be used in supporting a virtual processing environment. The central processing unit 48 or chipset could include a state machine or logic controller. When any of the central processing units 48 or chipsets execute instructions to perform “operations,” this could include the central processing unit or chipset performing the operations directly and/or facilitating, directing, or cooperating with another device or component to perform the operations.

The communications network 82 may use packetized communications. When the computer system 22 communicates via the communications network 82, information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The communications network 82 may utilize any signaling standard. The cloud-computing environment 80 may mostly use wired networks to interconnect the network members 84. However, the cloud-computing environment 80 and the communications network 82 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud-computing environment 80 and the communications network 82 may also utilize other standards, such as the I.E.E.E. 802 family of standards, the Industrial, Scientific, and Medical band of the electromagnetic spectrum, BLUETOOTH®, low-power or near-field, and any other standard or value.

The entity identification service 88 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for determining the common entity 26, as the above paragraphs explain.

The diagrams, schematics, illustrations, and tables represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system for an entity matching, comprising:
receiving, by the computer system, different datasets associated with the entity matching;
generating, by the computer system, entity embeddings using an entity embedding model and entity byte n-grams extracted from the different datasets; and
determining, by the computer system, a common entity associated with the different datasets based on the entity embeddings.

2. The method of claim 1, further comprising generating the entity byte n-grams using entity attributes associated with the different datasets.

3. The method of claim 1, further comprising generating an entity embedding matrix based on the entity embeddings.

4. The method of claim 1, further comprising generating entity similarities based on the entity embeddings.

5. The method of claim 4, further comprising filtering the entity similarities according to a threshold value.

6. The method of claim 1, further comprising generating an entity similarity matrix based on the entity embeddings.

7. The method of claim 1, further comprising sorting the entity embeddings.

8. A computer system that determines a common entity associated with different user accounts, comprising:
a central processing unit; and
a memory device storing instructions that, when executed by the central processing unit, perform operations, the operations comprising:
receiving the different user accounts associated with an entity matching;
extracting entity byte n-grams from entity attributes associated with the different user accounts;
generating entity embeddings using an entity embedding model and the entity byte n-grams extracted from the entity attributes associated with the different user accounts;
determining entity similarities associated with the entity embeddings; and
determining the common entity associated with the different user accounts based on the entity similarities associated with the entity embeddings.

9. The computer system of claim 8, wherein the operations further comprise generating ranked entity similarities by ranking the entity similarities.

10. The computer system of claim 8, wherein the operations further comprise generating filtered entity similarities by filtering the entity similarities.

11. The computer system of claim 8, wherein the operations further comprise generating sorted entity embeddings by sorting the entity embeddings.

12. The computer system of claim 8, wherein the operations further comprise searching the entity embeddings according to an embedding search space.

13. The computer system of claim 8, wherein the operations further comprise generating an entity embedding matrix based on the entity embeddings.

14. The computer system of claim 13, wherein the operations further comprise generating an entity similarity matrix using the entity embedding matrix.

15. A memory device storing instructions that, when executed by a central processing unit, perform operations that determine a common entity associated with different user accounts, the operations comprising:
receiving the different user accounts associated with an entity matching;
extracting entity byte n-grams from entity attributes associated with the different user accounts;
generating an entity embedding matrix using an entity embedding model and the entity byte n-grams extracted from the entity attributes associated with the different user accounts;
generating an entity similarity matrix based on the entity embedding matrix; and
determining the common entity associated with the different user accounts based on entity similarities associated with the entity similarity matrix.

16. The memory device of claim 15, wherein the operations further comprise sorting entity embeddings associated with the entity embedding matrix.

17. The memory device of claim 15, wherein the operations further comprise determining a transposed entity embedding matrix based on the entity embedding matrix.

18. The memory device of claim 15, wherein the operations further comprise filtering entity similarities associated with the entity similarity matrix.

19. The memory device of claim 15, wherein the operations further comprise searching entity embeddings associated with the entity embedding matrix.

20. The memory device of claim 15, wherein the operations further comprise comparing entity similarities to a threshold entity similarity value.
